(19) United States
(12) Patent Application Publication
(10) Pub. No.: US 2002/0097732 A1
(43) Pub. Date: Jul. 25, 2002

(54) Virtual private network protocol

(76) Inventors: Tom Worster, Boston, MA (US); Paul Doolan, Milford, MA (US)

Correspondence Address: TESTA, HURWITZ & THIBEAULT, LLP, HIGH STREET TOWER, 125 HIGH STREET, BOSTON, MA, 02110, US

(21) Appl. No.: 09/798,688

(22) Filed: Mar. 2, 2001

Related U.S. Application Data
(60) Provisional application No. 60/263,129, filed on Jan. 19, 2001.

(51) Int. Cl. H04L 12/28; H04L 12/56

(52) U.S. Cl. 370/408; 370/409; 370/390

(57) ABSTRACT

The invention relates to a method of communicating in a network comprising a plurality of nodes arranged in a hierarchy including a transmitting node. The method includes the steps of: receiving information from the transmitting node by a first node of the plurality of nodes; receiving said information by at least one other node in the plurality of nodes from the first node; and sending by the at least one other node a first directed message to the first node; and sending by the first node a second directed message to the transmitting node.

### FIELD OF THE INVENTION

The invention relates to the field of communication and more specifically to the field of network protocols.

### BACKGROUND OF THE INVENTION

A Virtual Private Network (VPN) is an alternative solution to the problem of connecting geographically separate sites into a single private communications network. One standard approach previously has been to lease private telecommunications lines connecting distant sites and adding lines as necessary as the number of locations increased. Although private leased lines provide the requisite security and communications connectivity, such lines are expensive to lease. Another standard approach has been to utilize private virtual connections such as Frame Relay and Asynchronous Transfer Mode connections. In both of these approaches, however, the number of leased lines or virtual connections increases with the number of sites to be connected to the point that these approaches may become prohibitively costly and/or difficult to manage.

With the existence of large public networks such as those used by Internet Service Providers, the ability to connect widely separated geographic sites into a communications network became much easier and cheaper. Using VPN protocols, these geographically separated sites can function as if they are members of an independent private network despite having their communications transferred over a public communications network. Establishing VPN communications present numerous challenges, not the least of which is providing an efficient, scalable and reliable protocol for controlling VPN membership and communication details.

### SUMMARY OF THE INVENTION

The invention relates to a method of communicating in a network comprising a plurality of nodes arranged in a hierarchy including a transmitting node. The method includes the steps of: receiving information from the transmitting node by a first node of the plurality of nodes; receiving said information by at least one other node in the plurality of nodes from the first node; and sending by the at least one other node a first directed message to the first node; and sending by the first node a second directed message to the transmitting node.

The invention also relates to a method of controlling data flow in network comprising a plurality of nodes. The method includes the steps of: defining for a message a maximum permissible time delay in responding to a message from a transmitting node; and selecting, by a receiving node, an amount of time to respond to a message from said transmitting node. The amount of time for responding is greater than or equal to zero and less than or equal to the maximum permissible time delay.

### BRIEF DESCRIPTION OF THE DRAWINGS

The invention is pointed out with particularity in the appended claims. The drawings are not necessarily to scale, emphasis instead generally being placed upon illustrating the principles of the invention. Like reference characters in the respective drawing figures indicate corresponding parts. The advantages of the invention described above, as well as further advantages of the invention, may be better understood by reference to the description taken in conjunction with the accompanying drawings, in which:

FIG. 1 is a overview of an embodiment of a VPN network constructed in accordance with the invention;

FIG. 2 is a diagram of a data structure used in the embodiment of the VPN network shown in FIG. 1;

FIG. 3A is a pictorial representation of a process associated with the distribution of the data structure shown in FIG. 2; and

FIG. 3B contains block diagrams of embodiments of data structures of the present invention.

### DESCRIPTION OF A PREFERRED EMBODIMENT

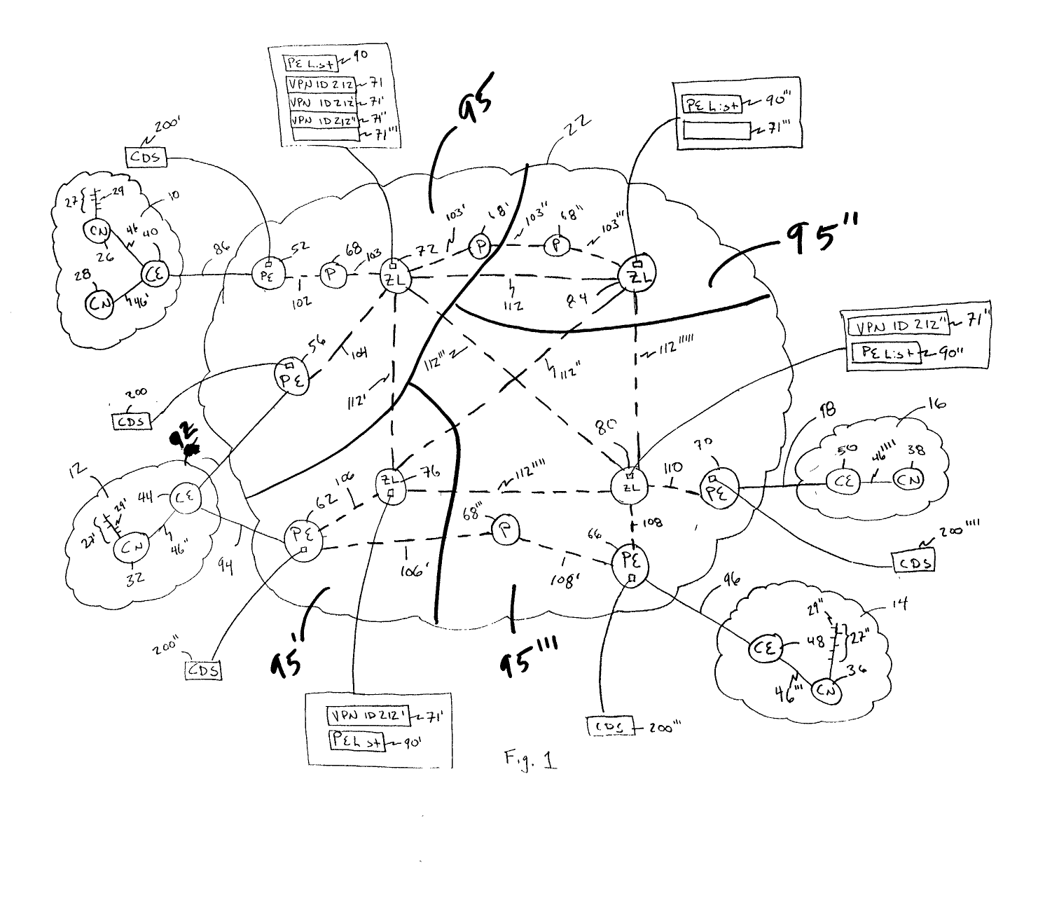

Referring to FIG. 1 and in brief overview, an embodiment of a VPN network constructed in accordance with the invention includes a plurality of customer sites 10, 12, 14, 16 and a provider network 22. Each customer site 10, 12, 14, 16 includes at least one customer edge (CE) node 40, 44, 48, 50 that is connected to at least one other customer node (CN) 26, 28, 32, 36, 38. In some embodiments the CE and the CN node are the same device. The customer nodes 26, 28, 32, 36, 3 8 can be various network devices such as hosts, Local Area Networks (LAN), routers and the like. In FIG. 1, customer node 26, 32, and 36 are shown connected to LANs 27, 27′, and 27″, respectively, each of which contains at least one host. The hosts 29, 29″ and 29″ each represent only one of the multiple hosts that are connected to each of the LANs 27, 27″ and 27″, respectively. The provider network 22 includes a plurality of provider edge (PE) nodes 52, 56, 62, 66, 70, optional provider (P) nodes 68, 68′, 68″, 68′″ (generally 68), and zone leader (ZL) nodes 72, 76, 80, 84. In this embodiment, the provider network 22 is divided into four zones: a first zone 95 including ZL node 72, PE nodes 52, 56, and P nodes 68, 68′, a second zone 95′ including ZL node 76 and PE node 62, a third zone 95″ including ZL node 84 and P node 68″, and a fourth zone 95′″ including ZL node 80, PE nodes 66, 70, and P node 68′″.

The customer nodes 26, 28 and 32 and 36 and 38 in customer sites 10 and 12 and 14 and 16, respectively, are connected via datalinks 46, 46′, 46″, 46′″, 46″″ to the customer edge nodes 40, 44, 48, 50 associated with the customer sites 10, 12, 14, 16, respectively. Each customer edge node 40, 48, 50, 44 is connected via a datalink 86, 96, 98, 92 and 94, repectively, to one PE node 52, 66, 70 or multiple PE nodes 56, 62 to provide access to the provider network 22. The connections 102, 104, 106, 108, 110 between the PE nodes 52, 56, 62, 66, 70, respectively, and the rest of the provider network provide for control communications between the PE nodes 52, 56, 62, 66, 70, internal P nodes 68 and ZL nodes 72, 76, 80, 84 of the provider network. Communications over the connections 102, 104, 106, 106′, 108, 108′, 110 from the PE nodes to the rest of the network are VPN Label Distribution Protocol (VLDP) sessions. Communications over the internal P node connections 103, 103′, 103″, 103′″ are also VLDP sessions. The ZL nodes 72, 76, 80, 84 are fully meshed (fully interconnected) by VLDP sessions 112, 112′, 112″, 112′″, 112″″, 112′″″ to each other ZL node 72, 76, 80, 84. As discussed below, the VLDP sessions are used for VPN control such as establishing tunnels, as discussed below, adding and removing sites from a VPN, and the like. Not shown in FIG. 1 are the datalinks of the provider network 22 that physically connect the PE nodes 52, 56, 62, 66, 70, the P nodes 68, and the ZL nodes 72, 76, 80, 84 and over which data packets are transmitted.

In the example shown in FIG. 1, assume that customer sites 10, 14, and 16 belong to a single VPN, while customer site 12 does not belong to that VPN. When hosts 29, 29″ on member sites of a VPN send and receive communications, for example when the host 29 on LAN 27 connected to the customer node 26 in the customer site 10, wants to communicate with the host 29″ on LAN 27″ connected to the customer node 36 in the customer site 14, the host 29 sends a message to customer edge node 40, which sends the message via datalink 86 to PE node 52. The PE node 52 has received information as to which PE node, in this example, PE node 66, with whom to establish a connection to send communications to hosts (for example 29″) on the LAN 27″. The PE node 52 has also received information as to how this connection is to be established and maintained. The connections through which data packets are sent are referred to as tunnels. Numerous protocols can be used to establish the connections. For example tunnels can be based on Multiprotocol Label Switching Label Switched Paths (MPLS-LSP), Secure IP tunnels (IPSec), General Routing Encapsulation (GRE) tunnels, and the like.

If a new customer site 12 becomes part of the VPN already made up of the customer sites 10, 14, 16, the PE nodes 56, 62 that control communications to and from the customer site 12 must provide to and receive from the other PE nodes 52, 62, 66, 70 or 52, 56, 66, 70, respectively, information that allows communications to take place. This information is encapsulated in communications data structures (CDS) 200, 200′, 200″, 200′″, 200″″ each of which contains the information necessary to establish communications with the PE nodes 56, 52, 62, 66, 70, respectively.

Although not shown in FIG. 1 and as discussed below, each PE node 52, 56, 62, 66, 70 that is a member of the VPN by virtue of its connection to one of the customer sites 10, 12, 14, 16 will have a CDS 200, 200′, 200″, 200′″, 200″″ for all of the other PE nodes 52, 56, 62, 66, 70 that are member of the same VPN. For example, before customer site 12 is added to the VPN including customer sites 10, 14, and 16, the PE node 52 would have the CDSs 200′″ and 200″″ for use in establishing tunnels with the PE nodes 66 and 70, respectively. In general, the PE nodes 52, 56, 62, 66, 70 of the VPN are fully meshed with tunnels. This means that in the current example once customer site 12 is added to the VPN, each of the PE nodes 52, 56, 62, 66, and 70 would have an independent tunnel to each of the other PE nodes 52, 56, 62, 66, and 70 that is a member of the same VPN.

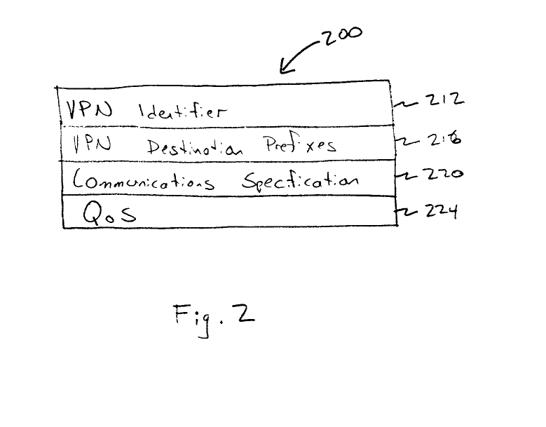

In the following the structure of the CDSs 200, 200′, 200″, 200′″, 200″″will be discussed with respect to the exemplary CDS 200 for the site 12 containing the host 29′. Referring also to FIG. 2 the information contained in the CDS 200 includes a VPN identifier 212 for uniquely distinguishing the VPN membership of the customer site 12. The VPN identifier 212 indicates to the receiving PE nodes 52, 66, 70 which VPN communications can use the communications information contained in the CDS 200. In the present example, the customer site 12 belongs to a single VPN, but in the situation where the customer site 12 belongs to multiple VPNs, the CDS 200 stores multiple VPN identifiers 212. The information in the CDS 200 also includes one or more VPN destination prefixes 216 identifying the hosts (in this example 29″) connected to the customer node 32 located on the particular customer site 12 and reachable through the attached PE node 56. In general if multiple hosts 29, 29′, 29″ and or multiple CN nodes 26, 28 32, 36, 38 are connected either directly or indirectly, as through a LAN 27, 27′, 27″ to a CE node 40, 44, 48, 50 on a customer site 10, 12, 14, 16 then the prefixes 216 would identify all such hosts 29, 29′, 29″ and CN nodes 26, 28, 32, 36, 38 that should be reachable from other customer sites 10, 12, 14, 16 using the VPN. As shown in FIG. 1, the customer node 32 is reachable through either the PE node 56 or the PE node 62 in order to provide more reliable communications. As a consequence of this, both the PE nodes 56, 62 will have information contained in the VPN destination prefix field 216 of the CDSs 200, 200″ that is adequate to identify the host 29″.

The information in the CDS 200 further includes a communications specification 220 such as an MPLS-LSP tunnel specification, that is used by the other PE nodes 52, 66, 70 to establish an MPLS-LSP tunnel with the PE node 56. The information in the CDS 200 lastly includes Quality of Service (QoS) characteristics 224 that defines various parameters such as the bandwidth of the connection established.

As part of the protocol of the present invention, the new CDS 200 is distributed to the existing PE nodes 52, 62, 66, 70 to enable them to establish communications with the newly added PE node 56. As the description for PE node 56 or PE node 62 is analogous, the following will consider the situation only from the perspective of the PE node 56. In response to the receipt of the message containing the CDS 200, the existing PE nodes 52, 62, 66, 70 return their CDSs 200′, 200″, 200′″, 200″″, respectively, to enable the newly added PE node 52 to establish communications with the existing members of the VPN. In addition, the existing PE nodes 52, 62, 66, 70 can optionally transmit messages to confirm their receipt of the CDS 200.

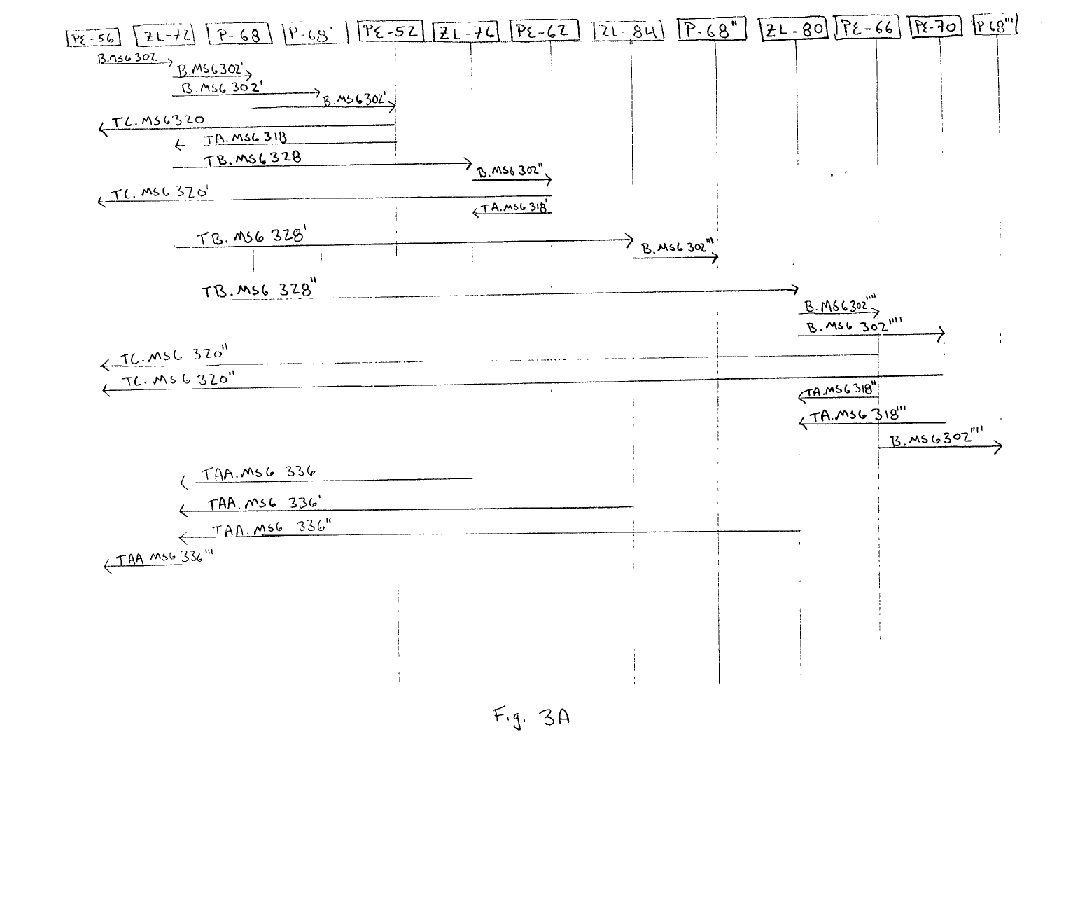

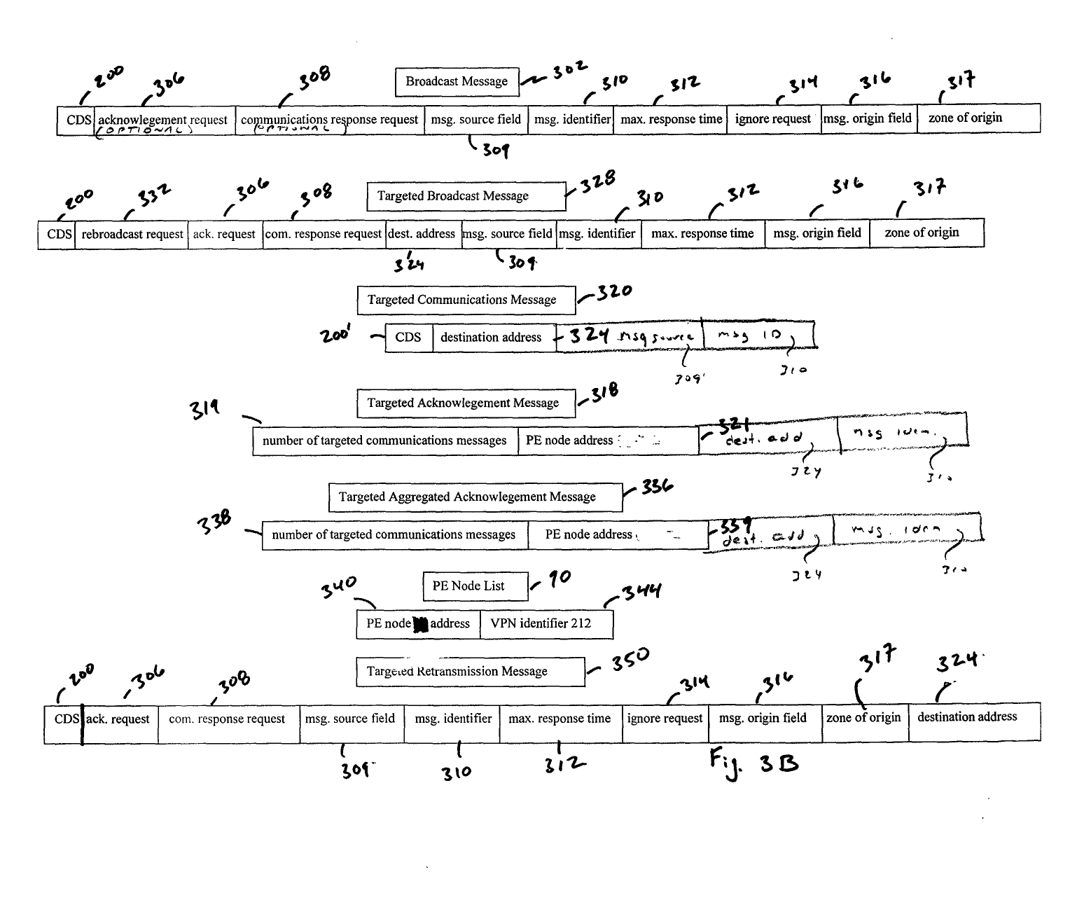

The present embodiment utilizes at least five types of messages as part of the procedure for adding a new customer site 12 to an existing VPN. The operation of the messages is discussed in detail below with respect to FIGS. 3A and 3B. A first message type is a broadcast message (generally, B.MSG in FIG. 3A) 302, 302′, 302″, 302′″, 302″″ that is used to distribute the CDS 200 within a zone. An initiating ZL node 72 transmits a second message type, (a targeted broadcast request message, generally TB.MSG in FIG. 3A) 328, 328′, 328″ to other ZL nodes 76, 80, 84 to request that the CDS 200 be rebroadcast within their zones. A third message type is a targeted communications message (generally, TC.MSG in FIG. 3A) 320, 320′, 320″, 320′″ that is used by the PE nodes 52, 62, 66, 70 to transmit the CDSs 200′, 200″, 200′″, 200″″, respectively, to the initiating PE node 56. A fourth message type is a targeted acknowledgement message (generally, TA.MSG in FIG. 3A) 318, 318′, 318″, 318′″ that is sent by the PE nodes 52, 62, 66, 70 to their respective ZL nodes 72, 76, 80 and includes the number of targeted communications messages 320, 320′, 320″, 320′″ transmitted by each PE node 52, 62, 66, 70, respectively. A fifth message type is a targeted aggregated acknowledgement message (generally, TAA.MSG in FIG. 3A) 336, 336′, 336″, 336′″ that is used by the ZL nodes 72, 76, 80 to summarize the targeted acknowledgement messages 318, 318′, 318″, 318′″, respectively, into a final single message returned to the initiating PE node 56. A sixth type of message used in one embodiment is a targeted retransmission message 350 that is employed by the ZL nodes 72, 76, 80, 84 when there exists a non-responsive PE node 52, 56, 62, 66, 70.

In the present embodiment when the originating PE node 56 transmits its new CDS 200, the PE node 56 sends it as part of a broadcast message 302. The details of the exemplary broadcast message 302 are shown in FIG. 3B and include the CDS 200 for the PE node 56 for the customer site 12, an acknowledgement request 306, a communications response request 308, a message source field 309 used as part of the acknowledgement procedure, a message identifier 310, a maximum response time 312, and an ignore request 314 that prevents the other PE nodes (in this example 52) within the zone of origin from using a CDS 200 flooded from the originating PE node 56.

The broadcast message 302 also includes a message origin field 316 that identifies the PE node 56 that originally sent the message and a zone of origin field 317 that identifies the zone of the originating PE node 56. The message identifier 310 in combination with message source field 309 uniquely identifies the broadcast message 302. The message identifier 310 is a numerical integer identifier added by the PE node 56 to all the messages that it transmits and this identifier's value is incremented by the PE node 56 each time that it transmits a message. As part of broadcasting the broadcast message 302, the PE node 56 sends it to all of the P nodes and ZL nodes (in this example 72) that are attached to the PE node 56.

Referring again to FIG. 3A, when the ZL node 72 receives the broadcast message 302 it first checks the message identifier 310 and message source field 309 to see if the ZL node 72 has already received this particular message. After determining that is has not, the ZL node 72 sends a broadcast message 302′ to all of its attached PE nodes (in this example 56) and P nodes (in this example 68 and 68′). The broadcast message 302′ is the same as the original broadcast message 302 except that the ZL node 72 has replaced the address of the originating PE node 56 with its own in the message source field 309, replaced the message identifier 310 with one of its own and changed the ignore request 313 value so that so that the broadcast message 302′ is not ignored by the zone 95 of the transmitting ZL node 72.

In general, when a PE node 52, 56, 62, 66, 70 or a P node 68 receives a broadcast message 302, 302′, 302″, 302′″, 302″″, it transmits the message to all of its attached PE nodes 52, 56, 62, 66, 70, ZL nodes 72, 76, 80, 84, or P 68 nodes that are within its zone except for the PE 52, 56, 62, 66, 70 or P 68 node that sent it the message. This is assuming that the PE 52, 56, 62, 66, 70, ZL nodes 72, 76, 80, 84, or P 68 node has not already received the message. If the message has already been received, then the PE 52, 56, 62, 66, 70 or P 68 node discards the message. After confirming that it has not already received the broadcast message 302′, the P node 68 broadcasts the broadcast message 302′ to the PE node 52 according to the general principles described above. The P node 68′ does not broadcast the broadcast message 302′ to the P node 68″ because the P node 68″ is not in the same zone as the P node 68′.

Upon receipt of the broadcast message 302′, the PE node 52 stores the CDS 200 for use in establishing future VPN communications with the newly added customer node 32. The PE node 56 also sends one or more targeted communications messages (in this example 320) directly to the originating PE node 56 in response to communications response request 308. As shown in FIG. 3B, the exemplary target communications message 320 includes the CDS 200′ and a destination address 324 so that the network can deliver the targeted communications message 320 directly to the originating PE node 56. The communications message 320 contains the address of the PE node 56 as the destination address 324. The destination address 324 is extracted from the message origin field 316. The targeted communications message 320 contains the CDS 200′ for the PE node 52 so that, upon receipt and storage, the PE node 56 is able to establish future VPN communications with the existing customer nodes 26 and 28.

Because an acknowledgement 306 was requested in the broadcast message 302′, the PE node 52 also sends a targeted acknowledgement message 318 to the address specified in the message source field 309, in this case to its zone leader, ZL node 72. As shown in FIG. 3B, the exemplary targeted acknowledgement message 318 indicates the number 319 of targeted communications message 320 sent by the receiving PE node 52 together with the address of its sender, i.e. PE node 52. The targeted communications message 320 also contains the destination address 324 of the ZL node 72 as specified in the message source field 309 of the broadcast message 302 and the message identifier 310 of the broadcast message 302. Together these fields allow the recieving ZL node 72 to associate the targeted acknowledgement message 318 with the corresponding broadcast message 302. As discussed below, the targeted acknowledgement message 318 also includes the address 321 of the responding PE node 52, the destination address 324 and the message identifier 310. In the example shown in FIG. 3A, the receiving PE node 52 sends a single targeted communications messages 320. Those skilled in the art will recognize, however, that the receiving PE node 52 could send multiple targeted communications messages 320. For example, when multiple communications specifications 220 exist for a given VPN identifier 212 each of these communications specifications 220 will be contained in a separate CDS 200. This would be the situation when, for example, different means existed to establish the tunnel that connects two end PE nodes (for example 52 and 56) controlling the VPN communications between the customer sites 10 and 12. The targeted acknowledgement message 318 is received by the ZL node 72. The aggregation of the acknowledgement messages by the ZL node 72 and the other ZL nodes 76, 80, 84 is discussed below in more detail.

In addition to sending the broadcast message 302′ to its zone, the ZL node 72 also sends targeted broadcast request messages 328, 328′, 328″ to the ZL nodes 76, 80, 84 to which it is attached. The exemplary targeted broadcast request message 328 is shown in more detail in FIG. 3B and includes the CDS 200, a rebroadcast request 332, an acknowledgement request 306, a communications response request 308, a destination address 324′, a message source field 309′ indicating the address of the ZL node 72, the message identifier 310, a max response time 312, the message origin field 316, and the zone of origin 317. Upon receipt of the targeted broadcast request message 328, the ZL node 76 determines that the message is intended for rebroadcast to its zone by the presence of the rebroadcast request 332.

Before sending the broadcast message 302″, similar to the broadcast message 302′ discussed above, to its zone, the ZL node 76 performs an input filter analysis. As part of this analysis, the ZL node 76 first maintains a zone VPN identifier list 71′ that includes the VPN identifier 212′ of the customer sites (in this example 12) attached to PE nodes (in this example 62) within its zone. Next, the ZL node 76 compares the VPN identifier 212 of the CDS 200 received in the targeted broadcast request message 328 with the VPN identifier 212′ from the zone VPN identifier list 71′. If there exists in the zone VPN identifier list 71′ at least one VPN identifier 212′ that is the same as the received VPN identifier 212, then the ZL node 76 rebroadcasts the CDS 200 to its zone. Although in the present example, the zone VPN identifier list 71′ contains only one VPN identifier 212′, those skilled in the art will readily recognize that in general a zone VPN identifier list 71, 71′, 71″, 71′″ will have multiple VPN identifiers 212, 212′, 212″ when a customer site 10, 12, 14, 16 belongs to multiple VPNs.

As in the first zone once the ZL node 76 has received the targeted rebroadcast request message 328, the ZL node 76 sends the broadcast message 302″ to all of its attached PE nodes (in this example 62) and P nodes. Upon receipt of the broadcast message 302″, the PE node 62 sends, in response to the communications response request 308, a targeted communications message 320′ containing its CDS 200″ to the originating PE node 56 and, in response to the acknowledgement request 306, a targeted acknowledgement message 318′ to its zone leader, ZL node 76.

The process is directly analogous for the third and fourth zones. The ZL node 72 sends targeted broadcast messages 328′ and 328″ to the ZL nodes 80, 84 respectively. After checking their zone VPN identifier lists 71″, 71′″, the ZL nodes 80, 84 send broadcast messages 302′″ and 302″″, respectively, to their zones. In the fourth zone, the PE nodes 66 and 70 send targeted communications messages 320″ and 320′″ containing their CDSs 200′″ and 200″″ to the originating PE node 56 in response to the communications response request 308. The PE nodes 66 and 70 also each send targeted acknowledgement messages 318″ and 318′″ to the ZL node 84. In addition, the PE node 66 sends the broadcast message 302″″ to the P node 68″″ as it is an attached PE 52, 56, 62, 66, 70, ZL nodes 72, 76, 80, 84, or P 68 node within its zone from which the PE node 66 did not receive the broadcast message 302″″. The P node 68′″ does not broadcast the broadcast message 302″″ to the PE node 62, because the PE node 62 is in a different zone. The P node 68′″ does not broadcast the broadcast message 302″″ to the PE node 66, because PE node 66 is the node from which P node 68′″ recieved the broadcast message 302″″.

In one embodiment of the present invention, the ZL nodes 72, 76, 80, 86 perform an aggregation of the targeted acknowledgment messages 318, 318′, 318″, 318′″. As part of the hierarchical aggregation procedure, the ZL nodes 76, 80, 84 send to the initiating ZL node 72 targeted aggregated acknowledgement messages 336, 336′, 336″. As shown in more detail in FIG. 3B, the exemplary targeted aggregated acknowledgement message 336 includes the total number of targeted communications messages (in this example 320′) sent by the PE nodes (in this example 62) in their zones and optionally the address of the PE nodes (in this example 62) that sent the targeted communications messages (in this example 320′). The initiating ZL node 72 combines this number with the number of targeted acknowledgment messages 318 that it received from its own zone. The ZL node 72 then sends a final targeted aggregated acknowledgement message 336′″ including the total number of targeted communications messages 320, 320′, 320″, 320′″ sent by the PE nodes 52, 62, 66, 70 to the originating PE node 56. As indicated above, this number provides an independent number for the originating PE node 56 to compare with the number of targeted communications messages 320, 320′, 320″, 320′″ that the PE node 56 received directly from the PE nodes 52, 62, 66, 70.

In an alternative embodiment, the targeted acknowledgment messages 318, 318′, 318″, 318′″ and the targeted aggregated acknowledgement messages 336, 336′, 336″, 336′″ include optional information that specifies the addresses of the PE nodes 52, 62, 66, 70 as well as the number of targeted communications messages 320, 320′, 320″, 320′″ sent by the PE nodes 52, 62, 66, 70. This allows the originating PE node 56 to send communications directly to the PE nodes 52, 62, 66, 70 if it determines that it did not receive a targeted communications messages 320, 320′, 320″, 320′″ from one of the PE nodes 52, 62, 66, 70.

In an additional alternative embodiment, the targeted aggregated acknowledgement messages 336, 336′, 336″ indicate whether the required targeted acknowledgement messages 318′, 318″, 318′″ were received and the ZL node 72 uses this information combined with the acknowledgement message 318 received from its zone to inform the PE node 56 whether all of the required targeted acknowledgement messages 318, 318′, 318″, 318′″ were received. In this embodiment, the ZL nodes 72, 76, 80, 84 each maintain a PE node list 90, 90′, 90″, 90′″ that identifies the PE nodes 52, 56, 62, 66, 70 in their zones and the VPN identifiers 212, 212′, 212″ that are associated with the PE nodes 52, 56, 62, 66, 70 by virtue of the customer VPN membership of the sites 10, 12, 14. For example, as shown in FIG. 3B, the PE node list 90 for the ZL node 72 includes information identifying the membership of the PE nodes 52 and 56. As shown in FIG. 3B, the information generally includes at least one PE node address 340 and a VPN identifier field 344 containing at least one VPN identifier 212 corresponding to the VPN membership of the attached customer sites 10, 12, 14, 16. In this example as mentioned above, the sites attached to the PE nodes 52 and 56 are the customer sites 10 and 12, respectively.

In this additional alternative embodiment when a ZL node 72, 76, 80, 84 sends a broadcast message 302′, 302″, 302′″, 302″″, it determines by comparing the VPN identifier 212 of the CDS 200 and the VPN identifiers 212, 212′, 212″ of the PE node list 90, 90′, 90″, 90′″ the number of targeted acknowledgement messages 318, 318′, 318″, 318′″ that it should receive and from which PE nodes 52, 56, 62, 66, 70 it should receive them. If it does not receive a targeted acknowledgement message 318, 318′, 318″, 318′″ from a PE node 52, 56, 62, 66, 70 that had the proper VPN identifier 212, 212′, 212″, then the ZL node 72, 76, 80, 84 transmits a targeted retransmission message 350 directly to the non-responding PE node 52, 56, 62, 66, 70. As shown in FIG. 3B the targeted retransmission message 350 includes the CDS 200, an acknowledgement request 306, a communications response request 308, a message source field 309″ indicating the address of the ZL node 72, 76, 80, 84 sending the message, a unique message identifier 310 selected by the ZL node 72, 76, 80, 84 , the max response time 312, the message origin field 316, the zone of origin 317, and a destination address 324″ corresponding to the non-responding PE node 52, 56, 62, 66, 70. If the targeted retransmission message 350 is also unacknowledged, then the ZL node 72, 74, 76, 80 retransmits the targeted retransmission message 350 and awaits a targeted acknowledgement message 318 a fixed number of times. For example in one embodiment the targeted retransmission message 350 is retransmitted three times.

If the non-responding PE node 52, 56, 62, 66, 70 acknowledges any of the retransmissions, then a targeted aggregated acknowledgement message 336 is sent and no further action is taken. If the non-responding PE node 52, 56, 62, 66, 70 does not acknowledge any of the retransmissions, however, then a targeted aggregated acknowledgement message 336 is still sent but further action is also taken. In particular, the PE node list 90, 90′, 90″, 90′″ for the identifying ZL node 72, 76, 80, 84 is adjusted by removing from the VPN identifier field 344 the VPN identifier 212 corresponding to that of the non-responded broadcast message 302′, 302″, 302′″, 302″″. Also, the management of the provider network 22 is notified of the apparent failure of the non-responding PE node 52, 56, 62, 66, 70.

In addition to modifications within the identifying zone 95, 95′, 95″, 95′″, the identifying ZL node 72, 76, 80, 84 initiates broadcast communications, analogous to those described above with respect to adding a site to a VPN, that the non-responding PE node 52, 56, 62, 66, 70 is no longer a member of the particular VPN and that the PE node's tunnels associated with that particular VPN identifier 212 are withdrawn. For example, if the ZL node 80 determined that the PE node 70 was non-responsive, then the ZL node 80 would send messages to the ZL nodes 72, 76, 84 for broadcast to their zones 95, 95′, 95″, respectively. Upon receipt of the messages, the PE nodes 52, 56, 62, and 66 would then withdraw any existing tunnels established with the PE node 70 and would remove the PE node 70 from the particular VPN. This final step includes removing the appropriate VPN identifier 212 from the CDS 200″″ for the non-responding PE node 70 stored by the other PE nodes 52, 56, 62, 66.

In this additional alternative embodiment, when ZL node 72 sends the targeted broadcast messages 328 it sets a retransmission timer and awaits the targeted aggregated acknowledgement messages 336, 336′, and 336″ to be recieved from each of the ZL nodes 76, 80, 84 to which it sent the targeted broadcast messages 328. If all expected targeted aggregated acknowledgement messages 336, 336′, and 336″ are recieved before the retransmission timer expires, then the targeted aggregated acknowledgement message 336′″ is sent to the PE node 56 in the manner described above. If however the retransmission timer expires before all of the targeted aggregated acknowledgement messages 336, 336′, and 336″ are received, then ZL node 72 resets the retransmission timer and resends the targeted broadcast messages 328 to those ZL nodes 76, 80, 84 from which it did not receive targeted aggregated acknowledgement messages 336, 336′, and 336″. Such resetting of the retransmission timer and resending of the targeted broadcast messages 328 is repeated a fixed number of times or until all expected targeted aggregated acknowledgement messages 336, 336″, and 336″ are recieved. In the case that the fixed number of repetitions is completed without reception of all expected targeted aggregated acknowledgement messages 336, 336′, and 336″, the management of the provider network 22 is notified of the apparent failure of the non-responding ZL node 76, 80, 84 and the aggregated acknowledgement message 336′″ is sent to the originating PE node 56.

In an alternative embodiment, the identifying ZL node 72, 76, 80, 84 retransmits the broadcast message 302′, 302″, 302′″, 302″″ including a new message identifier 310 to its zone, 95, 95′, 95′″, 95″. The PE nodes 52, 56, 62, 66, 70 that are functioning properly will process the broadcast message 302′, 302″, 302′″, 302″″ as described above.

According to one aspect of the present invention, the response time of the targeted communications messages 320, 320′, 320″, 320′″ is randomly varied to avoid overburdening the PE node 56 with an excess of targeted communications messages 320, 320′, 320″, 320′″ at any particular time. When the PE nodes 52, 62, 66, 70 receive the communications response request 308 they return their targeted communications messages 320, 320′, 320″, 320′″ within a period of time randomly chosen but constricted to fall within the range from zero to the max response time 312 specified in the original broadcast message 302. The max response time 312 is passed to the subsequent broadcast messages 302′, 302″, 302′″, 302″″.

The acknowledgement messages 318, 318′, 318″, 318′″ provide important robustness to the system by providing the originating PE node 56 with an independent number for confirming of the number of CDSs 200′, 200″, 200′″, 200″″ that it should have received for each PE node 52, 62, 66, 70. Those skilled in the art will recognize, however, the distribution of the new CDS 200 and the receipt of the existing CDSs 200′, 200″, 200′″, 200″″ could function without acknowledgement messages 318, 318′, 318″, 318′″ being sent.

Those skilled in the art will recognize that the above discussion has focused on the use of broadcast messages 302, 302′, 302″, 302′″, 302″″ in the context of adding a new customer site to a VPN. In this situation the newly added PE node 56 requires information as to how to communicate with the other PE nodes 52, 66, 70 of the VPN, and, therefore, targeted communications messages 320, 320′, 320″, 320′″ are required to return the existing CDSs 200′, 200″, 200′″, 200″″ to the newly added PE node 56. In general, however, there are numerous contexts in which broadcast messages 302, 302′, 302″, 302′″, 302″″ can be sent and such messages can include either or both of an acknowledgement request 306 and a communications response request 308. If, for example, the destination customer node 28 were being added to the existing customer site 10, then the PE node 52 would not need to receive the CDSs 200′″, 200″″ from the other PE nodes 66, 70 for the customer cites 14, 16 that are members of the same VPN because the PE node 52 would already have this information due to the preexisting customer node 26. In this case the PE nodes 66, 70 could still include an acknowledgement request 306 in its broadcastt message 302 so that PE node 52 could confirm both that the PE nodes 52, 62, 66, 70 recieved the corresponding broadcast messages 302′, 302″, 302′″, 302″″ and the number of CDSs 200′″, 200″″ that it had already stored based on the VPN membership of the customer node 26. Although this feature of the invention is optional, it provides assurances to users of the system that the VPN membership data is reliable.

While the invention has been particularly shown and described with reference to specific preferred embodiments, it should be understood by those skilled in the art that various changes in form and detail may be made therein without departing from the spirit and scope of the invention as defined by the appended claims.

Having shown the preferred embodiments, one skilled in the art will realize that many variations are possible within the scope and spirit of the claimed invention. It is therefor the intention to limit the invention only by the scope of the claims.

What is claimed is:

1. A method of communicating in a network comprising a plurality of nodes arranged in a hierarchy including a transmitting node, said method comprising the steps of:
receiving information from said transmitting node by a first node of said plurality of nodes;
receiving said information by at least one other node in said plurality of nodes from said first node;
sending by said at least one other node a first directed message to said first node; and
sending by said first node a second directed message to said transmitting node.

2. The method of claim 1 wherein:
said first directed message is an acknowledgement of receipt of said information by said at least one other node and
said second directed message is an aggregated acknowledgement formed in response to said acknowledgement of receipt of said information.

3. The method of claim 2 further comprising:
sending by said at least one other node at least one response to said transmitting node; and wherein said acknowledgment of receipt of said information includes a number of said at least one response sent to said transmitting node.

4. The method of claim 1 wherein said at least one other node in said plurality of nodes has an inferior position in said hierarchy as does said first node.

5. The method claim 1 wherein said transmitting node has associated group membership information for said transmitting node and for said at least one other node.

6. The method of claim 1 wherein said information from said transmitting node is connection information.

7. The method of claim 1 wherein said first node is a zone leader.

8. The method of claim 1 wherein said transmitting node is a provider edge node.

9. A method of communicating in a network comprising a plurality of nodes arranged in a hierarchy including a transmitting node, said method comprising the steps of:
receiving information from said transmitting node by a first node of said plurality of nodes;
sending by said first node said information to at least one other node of said plurality of nodes;
receiving said information from said at least one other node by at least one additional node of said plurality of nodes;
sending by said at least one additional node a first directed message to said at least one other node;
sending by said at least one other node a second directed message to said first node; and
sending by said first node a third directed message to said transmitting node.

10. The method of claim 9 wherein said at least one other node of said plurality of nodes has an equivalent position in said hierarchy as does said first node.

11. The method of claim 9 wherein said at least one additional node of said plurality of nodes has an equivalent position in said hierarchy as does said transmitting node.

12. The method of claim 9 wherein:
said first directed message is an acknowledgement of receipt of said information;
said second directed message is an aggregated acknowledgement formed in response to said acknowledgement of receipt of said information and
said third directed message is an aggregated acknowledgement formed in response to said acknowledgement of receipt of said information.

13. The method of claim 9 further comprising:
sending by said at least one additional node at least one response to said transmitting node; and wherein said acknowledgment of receipt of said information includes a number of said at least one response sent to said transmitting node.

14. The method claim 9 wherein said transmitting node has associated group membership information for said transmitting node and for said at least one additional node.

15. The method of claim 9 wherein said information from said transmitting node is connection information.

16. The method of claim 9 wherein said first node is a zone leader.

17. The method of claim 9 wherein said transmitting node is a provider edge node.

18. The method of claim 9 wherein said at least one other node is a zone leader.

19. The method of claim 9 wherein said at least one additional node is a provider edge node.

20. A method of communicating within a network including a zone, said zone comprising a plurality of nodes arranged in a hierarchy including a zone leader, said method comprising the steps of:
receiving a first broadcast message by said zone leader;
transmitting a second broadcast message by said zone leader in response to said receipt of said first broadcast message;
receiving a first directed message by said zone leader; and
transmitting a second directed message by said zone leader in response to said receipt of said first directed message.

21. The method of claim 20 further comprising maintaining by said zone leader at least one group membership list for nodes within said zone.

22. The method of claim 21 further comprising:
receiving a message by said zone leader for broadcasting to said zone;
comparing group membership data carried by said message with said group membership list; and
broadcasting said message to said zone when at least one group is common between said group membership carried by said message and said group membership list.

23. A method of controlling data flow in network comprising a plurality of nodes, said method comprising the steps of:
defining for a message a maximum permissible time delay in responding to a message from a transmitting node; and
selecting, by a receiving node, an amount of time to respond to a message from said transmitting node,
wherein said amount of time for responding is greater than or equal to zero and less than or equal to said maximum permissible time delay.

24. The method of claim 23 wherein said amount of time for responding is selected randomly.

25. A network comprising:
a first provider edge node;
a second provider edge node;
a zone leader capable of sending communications to and receiving communications from said first and said second provider edge nodes;
wherein said zone leader receives information from said first provider edge node,
wherein said second provider edge node receives said information from said zone leader,
wherein said second provider edge node sends a first directed message to said zone leader, and
wherein said zone leader sends a second directed message to said first provider edge node.

26. The network of claim 25 wherein:
said first directed message is an acknowledgement of receipt of said information and
said second directed message is an aggregated acknowledgement formed in response to said acknowledgement of receipt of said information.

27. The network of claim 26 wherein said second provider edge node sends at least one response to said first provider edge node and wherein said acknowledgment of receipt of said information includes a number of said at least one response sent to said first provider edge node.

28. The network of claim 25 further comprising a group membership list associated with said first provider edge node that includes group membership information for said first provider edge node and said second provider edge node.

29. The network of claim 25 further comprising:
a third provider edge node; and
a second zone leader capable of sending communications to and receiving communications from said zone leader and said third provider edge node.

30. The network of claim 29 wherein:
said third provider edge node receives said information from said second zone leader,
said third provider edge node sends a third directed message to said second zone leader, and
said second zone leader sends a fourth directed message to said zone leader.

31. The network of claim 30 wherein:
said third directed message is an acknowledgement of receipt of said information and
said fourth directed message is an aggregated acknowledgement formed in response to said acknowledgement of receipt of said information.

32. The network of claim 31 wherein said third provider edge node sends at least one response to said first provider edge node and wherein said acknowledgment of receipt of said information includes a number of said at least one response sent to said first provider edge node.

33. The network of claim 25 wherein said information from said first provider edge node is connection information.

34. The network of claim 25 further comprising:
a membership group list including group membership data for said first and said second provider edge nodes; and
a message including group membership information;
wherein said zone leader receives said message and compares said group membership information and said membership group list, and
wherein said zone leader broadcasts said message to said first and said second provider edge nodes when at least one group is common between said group membership information and said membership group list.

35. The network of claim 29 further comprising:
a membership group list including group membership data for said first and said second provider edge nodes; and
a message including group membership information,
wherein said second zone leader receives said message and compares said group membership information and said membership group list, and
wherein said second zone leader sends said message to said zone leader when at least one group is common between said group membership information and said membership group list.

36. The network of claim 27 further comprising a group membership list associated with said first provider edge node that includes membership information for said first provider edge node, said second provider edge node, and said third provider edge node.

37. A network comprising:
a transmitting node;
a receiving node in signal communication with said transmitting node; and
a maximum permissible time delay in responding to a message from said transmitting node;
wherein said receiving node selects an amount of time to respond to a message from said transmitting node, and
wherein said amount of time to respond is greater than or equal to zero and less than or equal to said maximum permissible time delay.

38. The network of claim 37 wherein said receiving node comprises a random time to respond generator and wherein said random time to respond generator selects said amount of time to respond to said message from said transmitting node.
